(19) United States
(12) Patent Application Publication
(10) Pub. No.: US 2009/0113939 A1
(43) Pub. Date: May 7, 2009

(54) FIBER-OPTIC COMPONENT AND METHOD FOR MANUFACTURING THE SAME

(76) Inventor: Eric Crumpton, Severna Park, MD (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/933,615

(22) Filed: Nov. 1, 2007

(51) Int. Cl. C03B 37/023; G02B 6/02

(52) U.S. Cl. 65/385; 385/123

(57) ABSTRACT

A fiber-optic component comprises a hollow casing defining an enclosed cavity therewithin, a fiber-optic unit disposed within the cavity, and a potting compound filling the cavity in the casing and encapsulating the fiber-optic unit of the fiber-optic component. The potting material has a compressive strength allowing the fiber-optic component to withstand pressure of up to 14,000 psi. A method for manufacturing the fiber-optic component comprises the steps of: providing the casing with the enclosed cavity therewithin, inserting the fiber-optic unit into the cavity, providing the potting material, and introducing the potting material into the cavity so that a space around the fiber-optic unit is filled with the potting material to encapsulate the fiber-optic unit.

### BACKGROUND OF THE INVENTION

1. Field of the Invention

This invention pertains to fiber-optic components in general and, more particularly, to a fiber-optic component including a fiber-optic unit and provided to withstand high pressure conditions and a method for manufacturing the same.

2. Description of the Prior Art

Unpowered or passive fiber-optic devices (or units) are essential part of a system that transmits video and data across a fiber optical cable. Fiber-optic cable transmission lines have become more widely used in various data transmission applications including passive fiber-optic devices because of their inherent capability of transmitting more data than any comparably sized electrical wire. Since fiber-optic cables do not produce electromagnetic interference and are not susceptible to radio frequency interference, they have become more desirable in computer systems and avionic systems and many other types of systems in which noise interference can cause malfunction thereof. Moreover, fiber-optic cable transmission systems have an additional advantage of having lower power requirements than electrical wire transmission lines of comparable data transmission capabilities.

The passive fiber-optic units are well known in the art and include various wavelength-division multiplexers (WDM), such as coarse wavelength-division multiplexers (CWDM), band splitters, and optical splitters. Specifically, the wavelength-division multiplexer is a passive (or unpowered) fiber-optic unit which multiplexes multiple optical carrier signals of different wavelengths on a single optical fiber by using different wavelengths (colors) of laser light to carry different signals. This allows for a multiplication in capacity, in addition to making it possible to perform bidirectional communications over one strand of fiber. The band splitter is known in the art as a multiplexer designed to split the available frequency band into several independent channels suitable for data transmission. A splitter is known in the art as a passive fiber-optic device which separates (splits) a single optical signal into two or more identical channels (optical fibers).

The passive fiber-optic units are available and in use for operating in various high pressure applications (at pressures up to 14,000 psi), such as under sea, in deep oil wells or the like. For example, in the under sea applications, the passive fiber-optic units, mounted to undersea robots or robotic vehicles, are subject to water pressure of up to approximately 14,000 psi. The passive fiber-optic units are subject to comparably high pressure also in decompressing chambers for deep sea divers or the like.

Typically, the passive fiber-optic units for high pressure applications are enclosed in specialized high-pressure casings to form passive fiber-optic components. In order to withstand elevated pressure conditions, these casings are usually custom fabricated of thick gauge titanium, aluminum, composite material or stainless steel to withstand high sub-sea pressures of up to 14,000 psi. However, such a construction makes the metal casings of the fiber-optic components heavy, bulky and expensive.

Thus, while known passive fiber-optic components, including but not limited to those discussed above, have proven to be acceptable for various high pressure applications, such components are nevertheless susceptible to improvements that may reduce their weight, size and cost. With this in mind, a need exists to develop improved passive fiber-optic components that advance the art.

### SUMMARY OF THE INVENTION

The present invention is directed to a novel fiber-optic component provided for operating in various high pressure applications, and a method for manufacturing the same.

According to one aspect of the invention, a fiber-optic component is provided for operating in various high pressure applications (at pressures up to 14,000 psi). The fiber-optic component comprises a hollow casing defining an enclosed cavity therewithin, a fiber-optic unit disposed within the cavity, and a potting compound filling the cavity in the casing and encapsulating the fiber-optic unit of the fiber-optic component. The potting material has a compressive strength allowing the fiber-optic component to withstand pressure of up to 14,000 psi.

According to another aspect of the invention, a method for manufacturing the fiber-optic component is provided. The method of the present invention comprises the following steps. First, a hollow casing with the enclosed cavity therewithin is provided. Next, the fiber-optic unit is inserted into the cavity in the casing. Then, the potting material is introduced into the cavity so that a space around the fiber-optic unit is filled with the potting material to encapsulate the fiber-optic unit. The potting material has the compressive strength allowing the fiber-optic component to withstand pressure of up to 14,000 psi.

### BRIEF DESCRIPTION OF THE DRAWINGS

Objects and advantages of the invention will become apparent from a study of the following specification when viewed in light of the accompanying drawings, wherein:

FIG. 1 is a perspective view of a fiber-optic component in accordance with a preferred embodiment of the present invention;

FIG. 2 is a perspective view of a fiber-optic unit of the present invention;

FIG. 3A is a horizontal cross-sectional view of the fiber-optic component according to the preferred embodiment of the present invention;

FIG. 3B is a vertical cross-sectional view of the fiber-optic component according to the preferred embodiment of the present invention;

FIG. 4A is a horizontal cross-sectional view of a casing of the fiber-optic component according to the preferred embodiment of the present invention;

FIG. 4B is a vertical cross-sectional view of the casing of the fiber-optic component according to the preferred embodiment of the present invention;

FIG. 4C is a front view of the casing of the fiber-optic component according to the preferred embodiment of the present invention;

FIG. 5A is a horizontal cross-sectional view of the casing of the fiber-optic component housing the fiber-optic unit therein prior to the step of introducing a potting material into a cavity in the casing according to the preferred embodiment of the present invention;

FIG. 5B is a vertical cross-sectional view of the casing of the fiber-optic component housing the fiber-optic unit therein prior to the step of introducing the potting material into the cavity in the casing according to the preferred embodiment of the present invention;

FIG. 6 shows the step of degassing a potting material;

FIG. 7 shows a board stack disposed in a pressure compensated housing.

### DESCRIPTION OF THE PREFERRED EMBODIMENTS

The preferred embodiments of the present invention will now be described with the reference to accompanying drawing.

For purposes of the following description, certain terminology is used in the following description for convenience only and is not limiting. The words such as “top” and “bottom”, “upper” and “lower”, “left” and “right” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

The present invention relates to a fiber-optic component for a multiplexer system that transmits video and data across a fiber optical link, or for a passive optical network that is known in the art as is a point-to-multipoint, fiber to the premises network architecture in which unpowered optical splitters are used to enable single optical fiber to serve multiple premises.

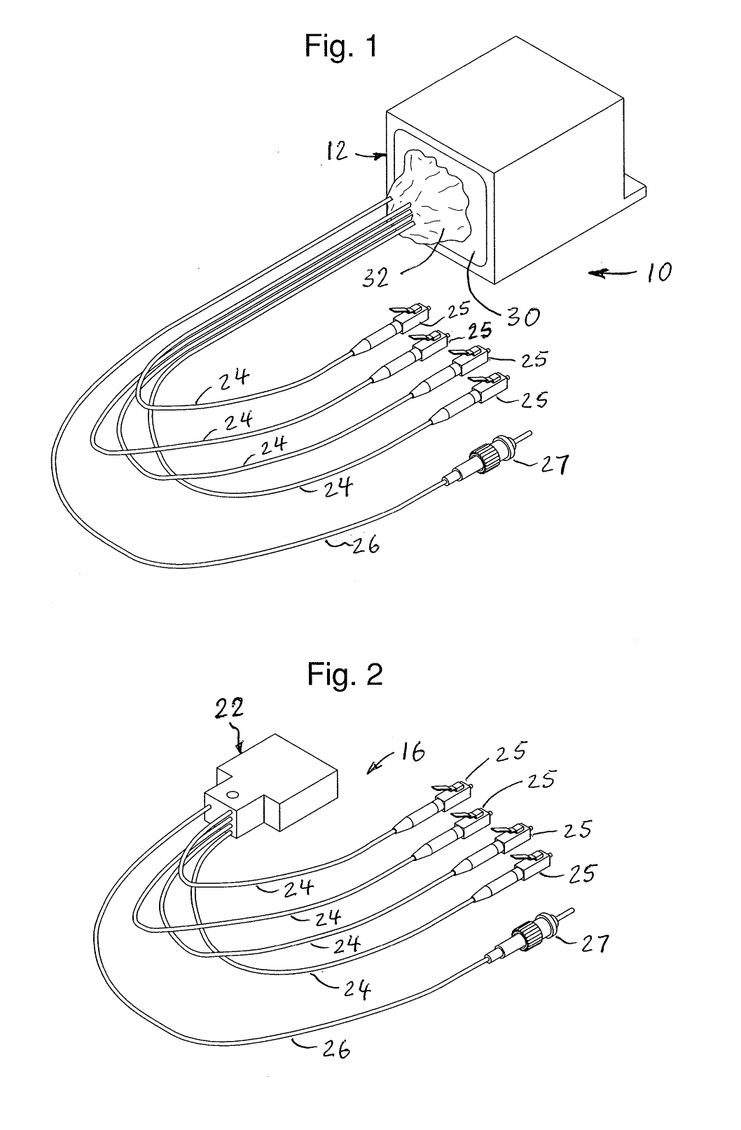

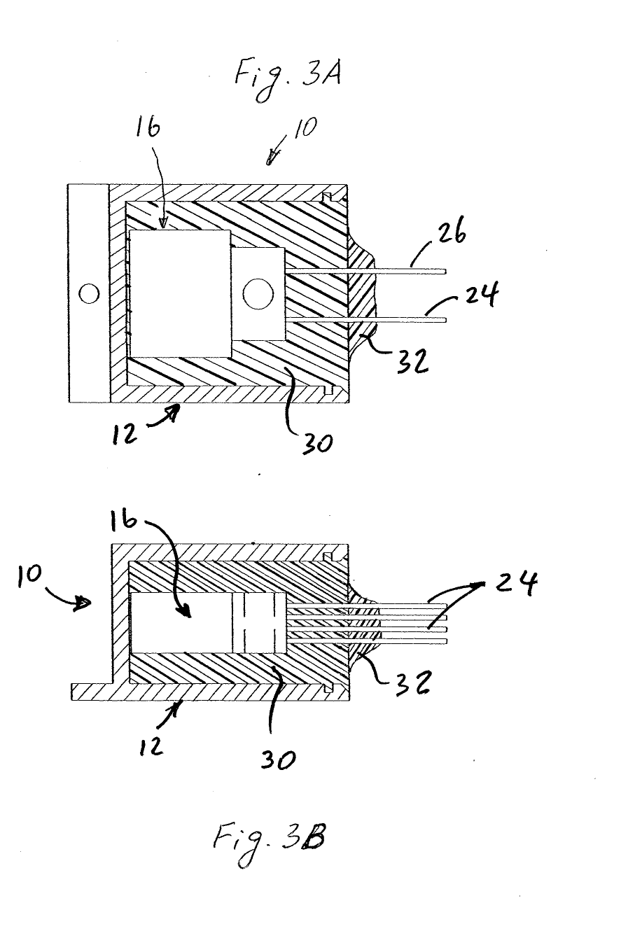

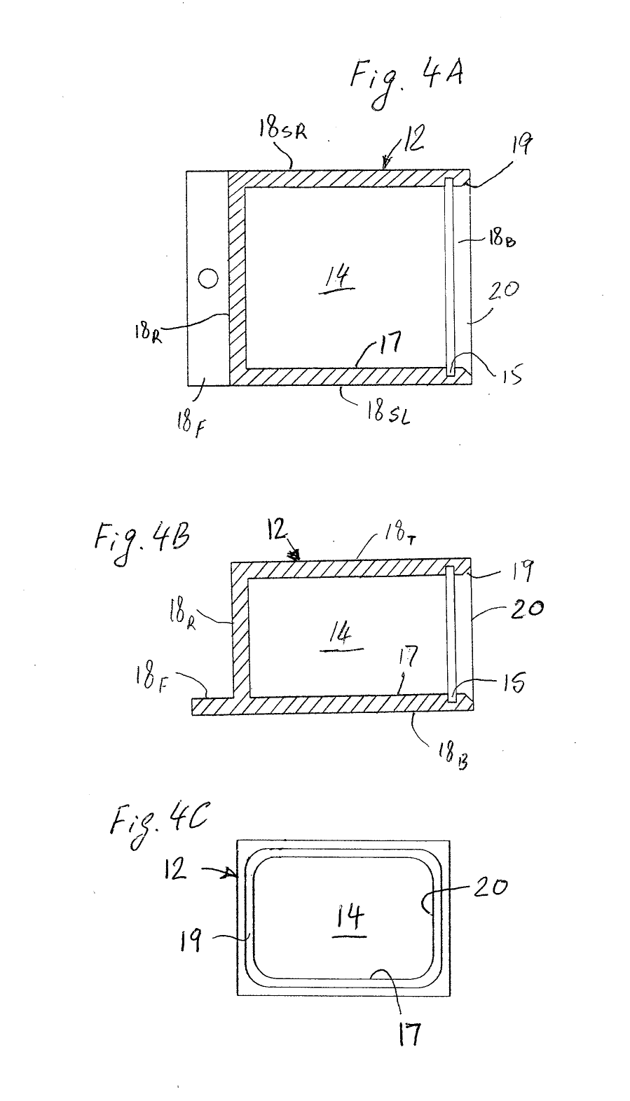

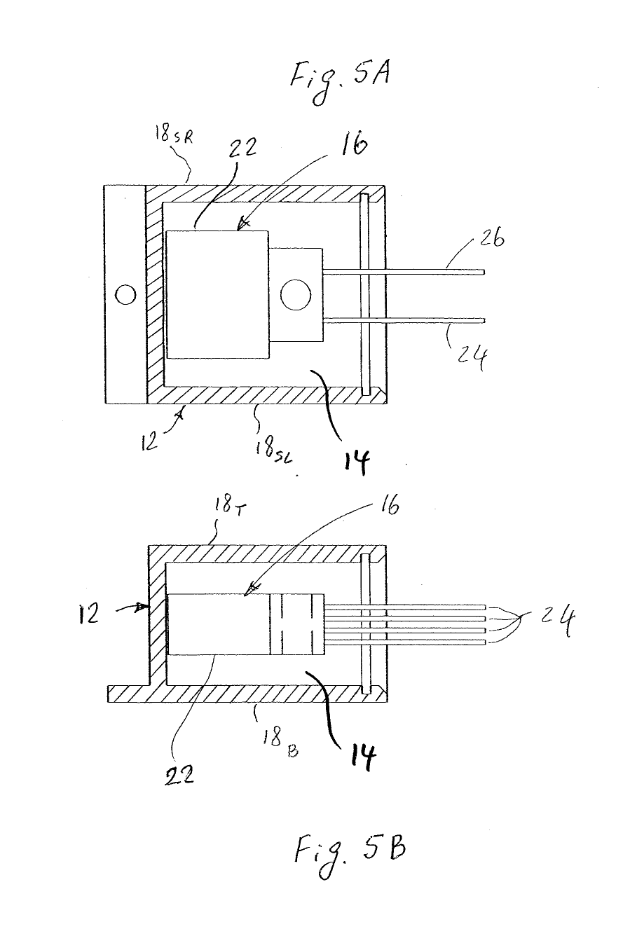

FIGS. 1, 3A and 3B of the drawings depicts a preferred exemplary embodiment of the fiber-optic component generally denoted by reference numeral 10. The fiber-optic component 10 comprises a hollow casing 12 defining an enclosed cavity 14 therein (illustrated in detail in FIGS. 4A-4C), and a passive (unpowered) or active (requiring the application of power) fiber-optic unit 16 (also shown in FIG. 2) disposed in the cavity 14 of the casing 12. The casing 12 has opposite top and bottom walls 18_{T} and 18_{B}, respectively, opposite right and left side walls 18_{SR} and 18_{SL}, respectively, a rear wall 18_{R}, and a flange 18_{F}. The casing 12 further defines an access opening 20 into the cavity 14 provided for inserting the fiber-optic unit 16 into the casing 12. The top and bottom walls 18_{T} and 18_{B}, and the right and left side walls 18_{SR} and 18_{SL} are formed with a continuous groove 15 provided on an inner peripheral surface 17 thereof adjacent to the access opening 20 of the casing 12. Moreover, distal end of the inner peripheral surface 17 adjacent to the access opening 20 is formed with a continuous bevel portion 19. Preferably, the casing 12 is made of non-corrosive metal, such as stainless steel or aluminum. It will be appreciated that alternatively the casing 12 may be made of any appropriate material, such as plastic.

The fiber-optic unit 16, as illustrated in FIG. 2, is in the form of a passive wavelength-division multiplexer (WDM). While the preferred embodiment of the present invention is described with reference to the fiber-optic component including the wavelength-division multiplexer, it will be appreciated that the present invention is equally applicable to any passive or active fiber-optic unit (either wavelength-division multiplexer, band splitter, or optical splitter) packaged into an enclosed casing to form a fiber-optic component for various high-pressure applications, such as under sea (underwater), in deep oil wells or the like.

The fiber-optic unit 16 includes a body 22, and a plurality of input fiber-optic cables 24 and a single output fiber-optic cable 26 extending outwardly from the body 22 thereof. Proximal ends of the input fiber-optic cables 24 and the output fiber-optic cable 26 are disposed within the body 22 of the multiplexer 16, while distal ends thereof are provided with appropriate cable connectors 25 (for input fiber-optic cables 24) and 27 (for output fiber-optic cable 26).

The cavity 14 of the casing 12 is formed so as to accommodate and protect the fiber-optic unit 16. A space in the enclosed cavity 14 of the casing 12 around the fiber-optic unit 16 is filled with a potting material 30, as illustrated in FIGS. 3A and 3B. According to the present invention, the potting material 30 has compressive strength of no less than 8,000 psi (when fully cured and hardened). The compressive strength is a measure of material's ability to withstand a compression force without failure. Preferably, the potting material 30 has compressive strength from about 8,000 psi to about 15,000 psi. The potting material 30 may be of any composition known to a worker skilled in the art. This may include potting material that is cured (hardened) with the application of heat or the potting material that is mixed just prior to the filling of the cavity 14 and that hardens due to the mixture of several components. In the exemplary embodiment of the present invention, the thermally conductive epoxy potting compound 832-TC produced by the MG Chemicals is used as the potting material 30 filling the cavity 14 of the casing 12. The conventional potting material has a compressive strength (after hardening) of well below 5,000 psi when fully cured and hardened. For example, the above mentioned potting compound 832-TC produced by the MG Chemicals when fully cured and hardened has the compressive strength of only 4,088 psi. Such value of the compressive strength of the conventional potting material is not sufficient for high pressure applications subject to pressure up to 14,000 psi, e.g. under sea, in deep oil wells or the like. Therefore, prior to being introduced into the cavity 14, the original potting material is degassed (i.e. freed from air bubbles therein) in order to substantially increase the compressive strength thereof. Alternatively, the potting material 30 may be used that has the compressive strength of at least 8,000 psi (when fully cured and hardened) without degassing, such as the thermally conductive epoxy potting compound STYCAST® 1495 K having the compressive strength of 14100 psi.

In order to provide strain relief and prevent the input and output fiber-optic cables 24 and 26 from bending, portions of the fiber-optic cables 24 and 26 extending from the potting material 30 adjacent to the access opening 20 of the casing 12 are embedded into an appropriate elastomeric material 32, such as a room-temperature vulcanizing (RTV) silicone rubber. The RTV silicone rubber is available as an easy-to-apply single-component material with uncured consistencies ranging from a low-viscosity brush-on material for thin coats, to a medium viscosity self-leveling form for use on level surfaces, to a high-viscosity no-run paste for vertical and overhead applications. The RTV silicone rubber cures at room temperature, and is usable over a temperature range of −75 deg to +550 deg F. (−60 deg to +290 deg C.). Moreover, the RTV silicone rubber has a low modulus of elasticity that is well suited for strain relief of the fiber-optic cables 24 and 26. Also, the RTV silicone rubber provides the fiber-optic cables 24 and 26 with good protection from mechanical abuse, provides good protection from water and resists many chemicals.

A method for manufacturing (forming) the fiber-optic component 10 according to the preferred embodiment of the present invention comprises the following steps.

First, the casing 12 are provided. The casing 12 is formed with an access opening 20 provided for introducing the fiber-optic unit 16 and the potting material 30 into the cavity 14.

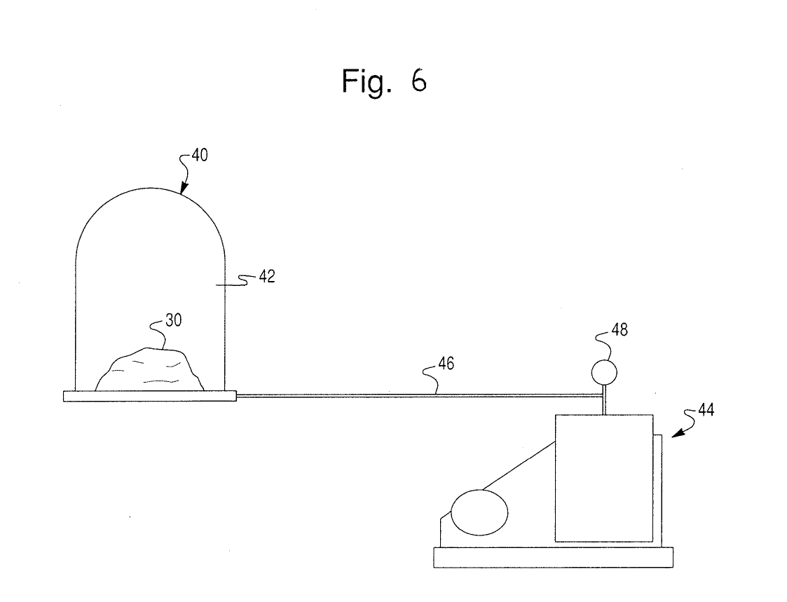

Next, the fiber-optic unit 16 is placed into the cavity 14 of the casing 12 so as to provide a space between the fiber-optic unit 16 and the opposite top and bottom walls 18_{T} and 18_{B}, and the opposite right and left side walls 18_{SR} and 18_{SL} of the casing 12, as illustrated in FIGS. 5A and 5B. Thus, the fiber-optic unit 16 is disposed within the cavity 14 so as to provide the space in the enclosed cavity 14 around the fiber-optic unit 16.

In the following method step, the conventional potting material, such as the potting compound 832-TC produced by the MG Chemicals mentioned above, is provided. Then, the original potting material is mixed and degassed (i.e. freed from air bubbles therein) in order to substantially increase the compressive strength thereof.

Specifically, prior to being introduced into the cavity 14, the original potting material 30 is mixed and put into a vacuum chamber 42 within a vacuum bell jar 40 for degassing, as illustrated in FIG. 6. The vacuum chamber 42 of the vacuum bell jar 40 is fluidly connected to a vacuum pump 44 through a vacuum line 46. Once the vacuum within the vacuum chamber 42 reaches 29-30 inches of mercury (as monitored by a vacuum gauge 48), the original potting material will begin to rise, resembling foam. Further increase of the vacuum causes the potting material to fall and not rise any more because substantially all air is removed from the potting material 30. At this point, the potting material 30 is substantially degassed. Preferably, the process of vacuuming continues for about 20 more minutes to make certain that all of the air has been removed from the original potting material.

Subsequently, the potting material 30 is introduced into the cavity 14 of the casing 12 using any appropriate technique known in the art. For example, the degassed potting material 30 may be put into a syringe (not shown) and introduced into the cavity 14 using the syringe, or the casing 12 may be put into a mold and the degassed potting material 30 introduced into the cavity 14 using any appropriate injection machine. The degassed potting material 30 is introduced (injected) into the cavity 14 of the casing 12 of the fiber-optic component 10 through the access opening 20 naturally flows within and fills the cavity 14 encapsulating the fiber-optic unit 16. The groove 15 and the bevel portion 19 of the casing 12 provide better sealing for the fiber-optic unit 16 within the casing 12.

It will be appreciated that above process of injecting the degassed potting material into the casing 12 does not usually introduce any new bubbles into the degassed (vacuumed) potting material. However, in order to insure that the potting material 30 is completely devoid of air bubbles, the entire fiber-optic component 10 is placed back into the vacuum chamber 42 of the vacuum bell jar 40 for a few additional minutes right after filling the casing 12 with the potting material but before the potting material hardens (or cures) for an additional (repeated) degassing. This process step of additional (second or repeated) degassing also assists the degassed potting material to fill difficult to reach areas of the cavity 14 of the casing 12 in order to completely fill the cavity 14.

Then, the potting material 30 is either cured by the application of heat or generates heat on its own due to the chemical reactions required by mixing several components to create a hardened mixture. In the exemplary embodiment of the present invention, the fiber-optic component 10 is heated in an oven (not shown) to 60° C. to cure and harden the potting material 30 within the casing 12.

Subsequently, once the potting material 30 has fully cured, the fiber-optic component 10 is trimmed to remove burrs of the excess potting material extending from the casing 12, and the access opening 20 is sealed with the potting material 30 in flush with front edges of the walls 18_{T} and 18_{B}, and 18_{SR} and 18_{SL} of the casing 12.

After that, the RTV silicone rubber material 32 is applied around the portions of the fiber-optic cables 24 and 26 extending from the potting material 30 adjacent to the access opening 20 of the casing 12 in order to provide strain relief and prevent the input and output fiber-optic cables 24 and 26 from bending.

Finally, after the RTV silicone rubber material 32 is cured, the fiber-optic transceiver 10 is tested and pressure cycled under fluid pressure of about 14,000 psi. Alternatively, the RTV silicone rubber material 32 can be applied around the portions of the fiber-optic cables 24 and 26 after the fiber-optic component 10 is tested and pressure cycled under fluid pressure of about 14,000 psi.

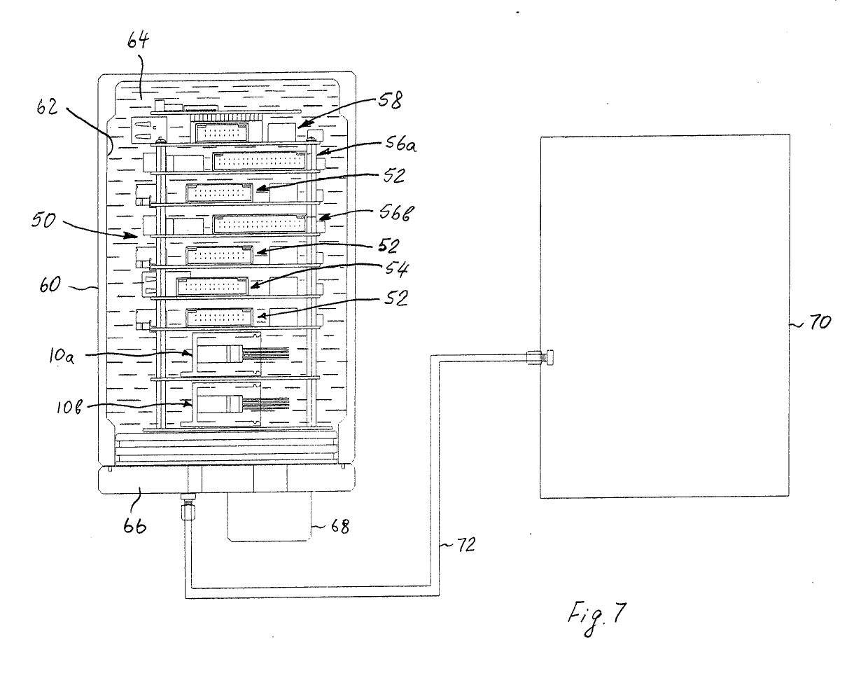

The fully assembled fiber-optic component 10 along with other is placed into a board stack 50, as illustrated in FIG. 7. The board stack 50 typically comprises a number of optical and electronic equipment, including fiber-optic components 10a and 10b according to the present invention, used in various high pressure applications, such as on undersea robots or robotic vehicles. In the exemplary embodiment of FIG. 7, the fiber-optic component 10a is in the form of a coarse wavelength-division multiplexer (CWDM), while the fiber-optic component 10b is in the form of a 1×2 band splitter. The electronic equipment of the board stack 50 includes various electronic components, such as fiber-optic multiplexers 52, 4 port Ethernet device 54, fiber-optic signal transmitters 56a and 56b, and a USB hub 58.

As further illustrated in FIG. 7, the board stack 50 is disposed in a pressure-compensated housing 60 forming a pressure chamber 62 therewithin. The pressure chamber 62 in the housing 60 is entirely filled with a liquid 64, preferably oil. The housing 60 is sealed with a lid 66. As the oil 64 (as any liquid) is non-compressible, the housing 60 allows the optical and electronic equipment disposed therewithin to withstand pressure of up to 14,000 psi. It will be appreciated that the groove 15 provide better sealing for the fiber-optic unit 16 within the casing 12 enhances sealing of the casing 12 as it creates labyrinth path, thus preventing oil entering the casing 12. The bevel portion 19 of the casing 12 further improves sealing of the casing 12. An electrical and fiber-optic connector 68 is mounted to the lid 66 outside the pressure chamber 62. Moreover, the oil filled pressure chamber 62 is hydraulically connected to a pressure compartment 70 through a hydraulic line 72 in order to pressurize and pressure-compensate the housing 60. In turn, the pressure compartment 70 is in fluid communication with external pressure, such as sea water pressure for undersea robots or robotic vehicles.

Therefore, the present invention provides a novel fiber-optic component and a method for manufacturing the same, which is securely protected in the high fluid-pressure environment by encapsulating a fiber-optic unit thereof with a potting material having a compressive strength allowing the fiber-optic component to withstand pressure of up to 14,000 psi. It will also be appreciated that the casing 12 can be of relatively thin gauge material (compared to the existing casings) and not very strong as the casing 12 does not bear a high-pressure load force of the elevated pressure conditions, such as to withstand high sub-sea pressures. Consequently, the casing 12 may be relatively light and inexpensive in manufacturing.

The foregoing description of the preferred embodiment of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. A method for manufacturing a fiber-optic component, said method comprising the steps of:
a) providing a casing defining an enclosed cavity therewithin;
b) inserting a fiber-optic unit into said cavity;
c) providing a potting material; and
d) introducing said potting material into said cavity so that a space around said fiber-optic unit being filled with said potting material to encapsulate said fiber-optic unit;
said potting material having said compressive strength allowing said fiber-optic component to withstand pressure of up to 14,000 psi.

2. The method for manufacturing said fiber-optic component as defined in claim 1, wherein said step of providing said potting material includes the step of degassing said potting material so as to make said potting material substantially free of air bubbles.

3. The method for manufacturing said fiber-optic component as defined in claim 2, wherein the step of degassing said potting material includes the step of vacuuming said potting material in a vacuum chamber by a vacuum pump.

4. The method for manufacturing said fiber-optic component as defined in claim 3, wherein said compressive strength of said potting material after the step of degassing said potting material is at least 8,000 psi.

5. The method for manufacturing said fiber-optic component as defined in claim 1, wherein the step of providing said casing includes the step of providing an access opening in said casing.

6. The method for manufacturing said fiber-optic component as defined in claim 5, wherein step of introducing said potting material into said cavity is conducted through said access opening.

7. The method for manufacturing said fiber-optic component as defined in claim 2, further comprising the step of additional degassing of said potting material within said casing subsequent to the step of introducing said potting material into said cavity.

8. The method for manufacturing said fiber-optic component as defined in claim 7, wherein the step of additional degassing of said potting material includes the step of vacuuming said potting material in a vacuum chamber by a vacuum pump.

9. The method for manufacturing said fiber-optic component as defined in claim 1, further comprising the step of curing said potting material in said casing in order to harden said potting material subsequent to the step of introducing said potting material into said cavity.

10. The method for manufacturing said fiber-optic component as defined in claim 9, wherein said step of curing said potting material includes the step of heating said fiber-optic component in order to cure and harden said potting material in said casing.

11. The method for manufacturing said fiber-optic component as defined in claim 9, further comprising the step of testing said fiber-optic component under fluid pressure of about 14,000 psi subsequent to the step of curing said potting material.

12. The method for manufacturing said fiber-optic component as defined in claim 9, wherein said compressive strength of said potting material hardened subsequent to the step of curing said potting material in said casing is at least 8,000 psi.

13. The method for manufacturing said fiber-optic component as defined in claim 1, wherein said fiber-optic unit is one of a wavelength-division multiplexer, a band splitter and an optical splitter.

14. The method for manufacturing said fiber-optic component as defined in claim 9, further comprising the step of placing said fiber-optic component in a pressure chamber defined in a pressure-compensated housing entirely filled with a liquid.

15. A fiber-optic component comprising:
a hollow casing defining an enclosed cavity therewithin;
a fiber-optic unit disposed within said cavity; and
a potting compound filling said cavity in said casing and encapsulating said fiber-optic unit;
said potting material having a compressive strength allowing said fiber-optic component to withstand pressure of up to 14,000 psi.

16. The fiber-optic component as defined in claim 15, wherein said compressive strength of said potting material is at least 8,000 psi.

17. The fiber-optic component as defined in claim 16, wherein said potting material is substantially free of air bubbles.

18. The fiber-optic component as defined in claim 17, wherein said potting material is degassed prior to filling said cavity in said casing.

19. The fiber-optic component as defined in claim 18, wherein said degassing of said potting material was conducted in a vacuum chamber by a vacuum pump.

20. The fiber-optic component as defined in claim 15, wherein said fiber-optic unit is one of a wavelength-division multiplexer, a band splitter and an optical splitter.

21. The fiber-optic component as defined in claim 15, wherein said hollow casing is provided with an access opening for inserting a fiber-optic unit into said cavity and introducing said potting material into said cavity so that a space around said fiber-optic unit is filled with said potting material to encapsulate said fiber-optic unit.

22. The fiber-optic component as defined in claim 15, wherein said fiber-optic component is disposed in a pressure chamber defined in a pressure-compensated housing entirely filled with a liquid.

23. The fiber-optic component as defined in claim 22, wherein said pressure chamber is hydraulically connected to a pressure compartment; said pressure compartment is in fluid communication with external pressure.
